(19) United States
(12) Patent Application Publication
(10) Pub. No.: US 2006/0010472 A1
(43) Pub. Date: Jan. 12, 2006

(54) System, method, and apparatus for creating searchable media files from streamed media

(76) Inventor: Balazs Godeny, Veresegyhaz (HU)

Correspondence Address: Hollingsworth & Funk, LLC, Suite 125, 8009 34th Avenue South, Minneapolis, MN, 55425, US

(21) Appl. No.: 10/885,518

(22) Filed: Jul. 6, 2004

(51) Int. Cl. G06F 13/00; H04N 7/16; G06F 3/00; H04N 5/445

(52) U.S. Cl. 725/62; 725/39

(57) ABSTRACT

A mobile terminal creates searchable media files through enhancement of the media files using related metadata, whereby media streams and related metadata are received and buffered in response to the user's commands. Search requests may then be issued by the user, in which previously buffered media streams may be recalled based on metadata related search criteria provided by the user. If the search request yields the requested media stream, the media stream is recalled from the buffer and provided to the user via a secondary media channel, while media stream collection continues in the background.

### FIELD OF THE INVENTION

This invention relates in general to media file generation, and more particularly, to searchable media file generation.

### BACKGROUND OF THE INVENTION

The mobile communication industry has experienced a period of exceptional growth during the last several years. New service enablers such as the Multimedia Messaging Service (MMS), Java, and the Extensible Hypertext Markup Language (XHTML) will continue to enable compelling new data and services for consumers and new sources of growth for the mobile industry. The development of these mobile services will continue to grow by using consumer behavior, the business structure surrounding the mobile service domains and technology.

To insure successful take-up of the evolving mobile services, however, the consumers must be able to discover them and subsequently consume them once they are discovered. Currently, mobile browsing is the predominant method used for data and service consumption by the mobile terminal, but other methods may also be employed to discover data and services available to the mobile user. Multiple information sources, such as presence servers and streaming media broadcasts for example, may also be accessed by the mobile terminal for immediate consumption by the mobile terminal user.

While information may be accessed from several types of streaming media formats, it is nevertheless a deficiency in the prior art that prohibits the user from significantly interacting with the streaming media once it has been received. One particular deficiency of the prior art may be illuminated, for example, by examining the interaction between a consumer of Amplitude Modulation (AM)/Frequency Modulation (FM) radio broadcasts. In particular, a user is able to tune to an FM broadcast, via his or her mobile terminal, in order to listen to the show currently being broadcast. The user may not, however, return to portions of the streamed media previously broadcast without expending considerable amounts of manual effort in so doing.

For example, once tuned in to the radio broadcast, the user may be apprised as to the occurrence of a weather broadcast occurring just minutes before. In order for the user to hear the full weather broadcast, however, he or she may be relegated to listen to previously recorded snippets of the weather broadcast in order to find the location of the broadcast of interest within the mobile terminal's recording buffer. In such an instance, the user must manually search through the recording buffer for the beginning of the weather broadcast in order to hear the full broadcast as long as it still exists within the buffer.

In another prior art example, a digital radio broadcast system may be provided that allows the user to capture control data along with the multimedia data, so that the recorded multimedia clip may be identified by features such as artist name, song title or lyrics. Identifying data associated with the recorded multimedia clip, therefore, allows the user to skip over tracks that may be of no interest, or to recover favorite tracks on another programming service stream. Thus, the user is provided a limited amount of manual interaction with the recorded multimedia content, but there is no means provided that allows the user to automatically search through the recorded content and related control data using keywords associated with the control data.

Accordingly, there is a need in the communications industry for a system, method, and apparatus that facilitates an ability to allow a user to searchably interact with recorded media streams to easily locate them for playback or other uses.

### SUMMARY OF THE INVENTION

To overcome limitations in the prior art, and to overcome other limitations that will become apparent upon reading and understanding the present specification, the present invention discloses a system, method, and apparatus for facilitating enhanced metadata and real-time streaming media storage to facilitate metadata based keyword searches of the recorded media.

In accordance with one embodiment of the invention, a system for creating searchable media objects associated with a media stream received from a broadcasting entity of a network comprises a network terminal coupled to the network. The network terminal includes a broadcast receiver module coupled to the broadcasting entity and adapted to receive media streams from the broadcasting entity, a metadata module coupled to receive metadata relating to the received media streams and adapted to associate the metadata with the received media streams, and a data controller coupled to the broadcast receiver module and the metadata module and adapted to combine the media streams received from the broadcasting entity with the associated metadata to form the searchable media objects.

In accordance with another embodiment of the invention, a mobile terminal wirelessly coupled to a network which includes a broadcast element capable of providing broadcast content within the network. The mobile terminal comprises a broadcast receiver module coupled to the broadcast element and adapted to receive the broadcast content, a metadata module coupled to receive metadata relating to the broadcast content and adapted to associate the metadata with the broadcast content, and a data controller coupled to the broadcast receiver module and the metadata module and adapted to combine the broadcast content with the associated metadata to form media objects. The media objects are recalled in response to metadata based keyword searches performed on the media objects.

In accordance with another embodiment of the invention, a computer-readable medium having instructions stored thereon which are executable by a mobile terminal for facilitating searchable media file creation. The instructions perform steps comprising receiving media streams, receiving metadata associated with the received media streams, combining the media streams and metadata into searchable media files; buffering the searchable media files, and recalling the searchable media files for playback in response to keyword searches relating to the metadata.

In accordance with another embodiment of the invention, a method for creating and utilizing searchable media files comprises receiving media streams, collecting metadata associated with the media streams, combining the media streams with the metadata in a buffer, recalling the media streams from the buffer based on metadata keyword searches of the buffer, and replaying the recalled media stream while continuing to receive other media streams.

In accordance with another embodiment of the invention, a method of performing metadata based search of media files comprises generating search criteria from metadata keywords, selecting a search method to utilize, comparing the search criteria to metadata indexed media files in response to the search method selected, and recalling the metadata indexed media files in response to a search criteria match.

These and various other advantages and features of novelty which characterize the invention are pointed out with greater particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of a system, method, and apparatus in accordance with the invention.

### BRIEF DESCRIPTION OF THE DRAWINGS

The invention is described in connection with the embodiments illustrated in the following diagrams.

FIG. 1 is an exemplary communications network that may be utilized by a mobile terminal operating in accordance with the present invention;

FIG. 2 illustrates a functional block diagram of a mobile terminal in accordance with the present invention;

FIG. 3 illustrates an exemplary browsing session in accordance with the present invention;

FIG. 4 illustrates an exemplary buffer array in accordance with the present invention;

FIG. 5 illustrates an exemplary media access block diagram in accordance with the present invention;

FIG. 6A illustrates a flow diagram in accordance with the present invention;

FIG. 6B illustrates an alternate flow diagram in accordance with the present invention; and

FIG. 7 illustrates an exemplary mobile computing environment in accordance with the present invention.

### DETAILED DESCRIPTION OF THE INVENTION

In the following description of the exemplary embodiments, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention is directed to a system, method and apparatus that allows a user of a landline or mobile terminal to store metadata relating to streamed broadcast media, as well as the media itself, for subsequent access via a browser or other data access mechanism. The metadata associated with the streamed media content may include any number of data objects that are relevant to the received media, such as track and album titles, composer name, artist name, lyrics associated with the recorded portion of the received broadcast, Uniform Resource Locators (URLs) associated with sales offices concerning the album titles, broadcast type, e.g., weather or traffic, media stream subject matter, etc. A search engine is employed to allow the user to search through the recently recorded media that is indexed according to the metadata associated with the broadcast to facilitate post recording transactions. The post recording transactions may include locating the media within the recording buffer for playback, while continuing to record one or more broadcast streams.

In one embodiment according to the present invention, the user, while listening to his favorite media broadcast, may become apprised as to interesting content previously transmitted by the broadcast, such as a traffic report, weather report, or the user's favorite song. In accordance with the present invention, access to the previously transmitted broadcast is provided to the user, through the use of a search utility, allowing the user to quickly recall previously recorded media streams based on metadata keywords that are associated with the particular broadcast of interest.

Metadata associated with the broadcast may be available from the transmission source itself, such as from a Radio Data Service (RDS) utility, an Electronic Program Guide (EPG), or other future metadata standards. In other embodiments, the metadata received via the RDS, EPG, or future metadata utilities may be augmented using alternate sources that are separate from the transmission source, such as from a presence server, content server, or from the broadcast station's URL. In any case, streamed media broadcasts along with their associated metadata may be buffered in the background while the user listens to them, so that future reference to the buffered content may be easily located through application of the metadata based search utility.

In an alternate embodiment, multiple media streams may be collected simultaneously, while the user is performing other tasks on the mobile terminal, or conversely, while the mobile terminal is otherwise in an idle state. The media streams may each be associated by a common theme, or may be totally independent media streams that are of interest to the user. Media streams that are associated by a common theme may include those related by broadcast type, such as for example a professional football broadcast, whereby multiple football games are each being broadcast simultaneously. The user may select multiple recording devices that are resident within his or her mobile terminal to buffer each of the multiple professional football broadcasts in their entirety.

Once buffered, the user is then offered several enhanced consumption opportunities relating to the multiple media streams. In a first instance, the user may only be interested in scoring events that have occurred within each of the recorded professional football broadcasts. As such, the associated metadata that is simultaneously being buffered with each broadcast may indicate, for example, a “scoring event” that is time tagged to the buffered media. Accordingly, the user is then able to issue a search command that is keyed to the metadata keyword “scoring event” for each buffered media stream. All search hits that are returned by the query are time tagged snippets of the buffered media, where each snippet reflects the recorded portion of the “scoring event” taking place on each buffered media stream.

Alternately, the user may wish to be alerted by his mobile terminal when such a “scoring event” occurs for any one or all of the buffered media streams. In such an instance, the mobile terminal may supply the user with an audible, visual, or tactile queue once any “scoring event” has taken place. Once queued, the user may then select the “scoring event” snippet for replay, or may select a permanent storage location for the snippet for later viewing. It should be noted that any number of media stream and metadata buffering/search scenarios may be facilitated by the present invention. The following detailed description of the operating environment provides only a few exemplary embodiments that are facilitated by the present invention and are not intended to be limiting, but are rather provided for exemplification purposes only.

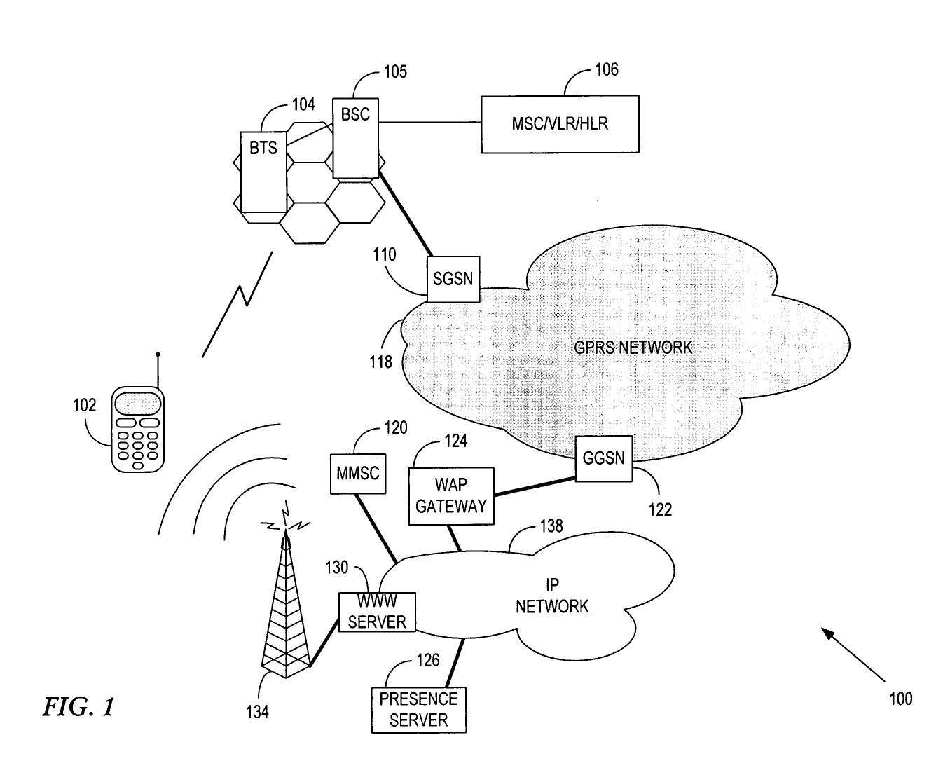

FIG. 1 illustrates exemplary communication network 100, such as a General Packet Radio Service (GPRS) network, that may be utilized by a mobile terminal that is operating in accordance with the present invention. GPRS is a packet-switched service for Global System for Mobile Communications (GSM) that mirrors the Internet model and enables seamless transition towards 3G (third generation) networks. GPRS thus provides actual packet radio access for mobile GSM and time-division multiple access (TDMA) users, and is ideal for Wireless Application Protocol (WAP) services. While the exemplary embodiments of FIG. 1 are generally described in connection with GPRS/GSM, it should be recognized that the specific references to GSM and GPRS are only provided as an exemplary operational environment. As will be readily apparent to those skilled in the art from the description provided herein, the invention is equally applicable to other technologies, including other circuit-switched and packet-switched technologies, 3G technologies, and beyond.

Mobile terminal 102 communicates with Base Transceiver Station (BTS) 104 via an air interface. BTS 104 is a component of the wireless network access infrastructure that terminates the air interface over which subscriber traffic is communicated to and from mobile terminal 102. Base Station Controller (BSC) 105 is a switching module that provides, among other features, handoff functions, and power level control in BTS 104. BSC 105 controls the interface between a Mobile Switching Center (MSC) 106 and BTS 104, and thus controls one or more BTSs in the call set-up functions, signaling, and in the use of radio channels. BSC 105 also controls the respective interfaces between Serving GPRS Support Node (SGSN) 110 and BTS 104.

SGSN 110 serves a GPRS mobile terminal by sending or receiving packets via a Base Station Subsystem (BSS), and more particularly via BSC 105 in the context of GSM systems. SGSN 110 is responsible for the delivery of data packets to and from mobile terminal 102, within the service area, and performs packet routing and transfer, mobility management, logical link management, authentication, charging functions that may be implicated by the present invention, etc. In the exemplary GPRS embodiment shown in FIG. 1, the location register of SGSN 110 stores location information such as the current cell and Visiting Location Register (VLR) associated with mobile terminal 102, as well as user profiles such as the International Mobile Subscriber Identity Number (IMSI) of all GPRS users registered with SGSN 110. SGSN 110 is ultimately coupled to Multimedia Messaging Service Center (MMSC) 120 in connection with the presently described embodiment. While GSM forms the underlying technology, SGSN 110 described above is a network element introduced through GPRS technology. Another network element introduced in the GPRS context is the Gateway GPRS Support Node (GGSN) 122, which acts as a gateway between the GPRS network 118 and WAP gateway 124.

MMSC 120 provides messaging capabilities for the delivery of multimedia messages composed of text, photographs, video, and other media types. The messaging capabilities include mobile originated messages sent to other mobile terminals or applications and application originated messages sent to mobile terminals or other applications. MMSC 120 is responsible for storing incoming and outgoing MMS messages, as well as the transfer of messages between different messaging systems, such as an e-mail service. In addition, MMSC 120 may provide an External Application Interface (EAIF) (not shown) that allows application developers and service providers to connect to MMSC 120 to offer value added services to mobile subscribers, such as for example, presence information supplied by presence server 126 that is subscribed to by mobile terminal 102.

Media broadcast tower 134 may represent a broadcast station, such as an AM/FM broadcast radio station or a Television (TV) broadcast station, having a transmission radius sufficient to reach mobile terminal 102. Mobile terminal 102, in addition to providing GPRS connectivity, also provides separate broadcast tuning, buffering, and search capability in accordance with the present invention. In other words, mobile terminal 102 provides complete voice and messaging functionality enabled by its GPRS capability, but also provides one or more media content channels enabled by its separate broadcast tuning, buffering and searching capabilities.

In a first embodiment, metadata associated with the buffered media stream is received directly from the broadcast itself. In particular, media broadcast tower 134 may be equipped with facilities that broadcast metadata associated with the media stream. In the case of a radio broadcast, RDS may be utilized for such a metadata transmission, while EPG may be used in relation to a digital video stream broadcast from a TV station. The RDS allows broadcast stations to transmit metadata that is multiplexed onto the same, or other, FM carrier that is used for the audio portion of the broadcast. MPG, on the other hand, lists programming and other metadata associated with current or future video stream programming.

In another embodiment, accessories available within mobile terminal 102 may be utilized to augment the directly received metadata with metadata that may be received indirectly. For example, media broadcast tower 134 may have Internet capability provided through the use of World Wide Web (WWW) server 130. Thus, while media broadcast tower 134 provides streamed media content and associated metadata to its listeners, e.g., mobile terminal 102, it may also interoperate within Internet Protocol (IP) network 138 through its Web page hosted by WWW server 130 to provide additional metadata.

In particular, media broadcast tower 134 may provide presence information to presence server 126 that may be of interest to mobile terminal 102. Such presence information, or metadata, may include: title of the “now playing” song of the broadcast; time tag associated with the beginning of the song; name of the artist performing the song; or biographical information about the artist. In addition, the presence server may supply a URL to a database containing previously streamed media from earlier broadcasts. The mobile terminal may then access the URL and perform a database search to find any media of interest. Once found, the mobile terminal may augment its own buffered media content with the content found on the external database by performing a media download from the external database to the mobile terminal.

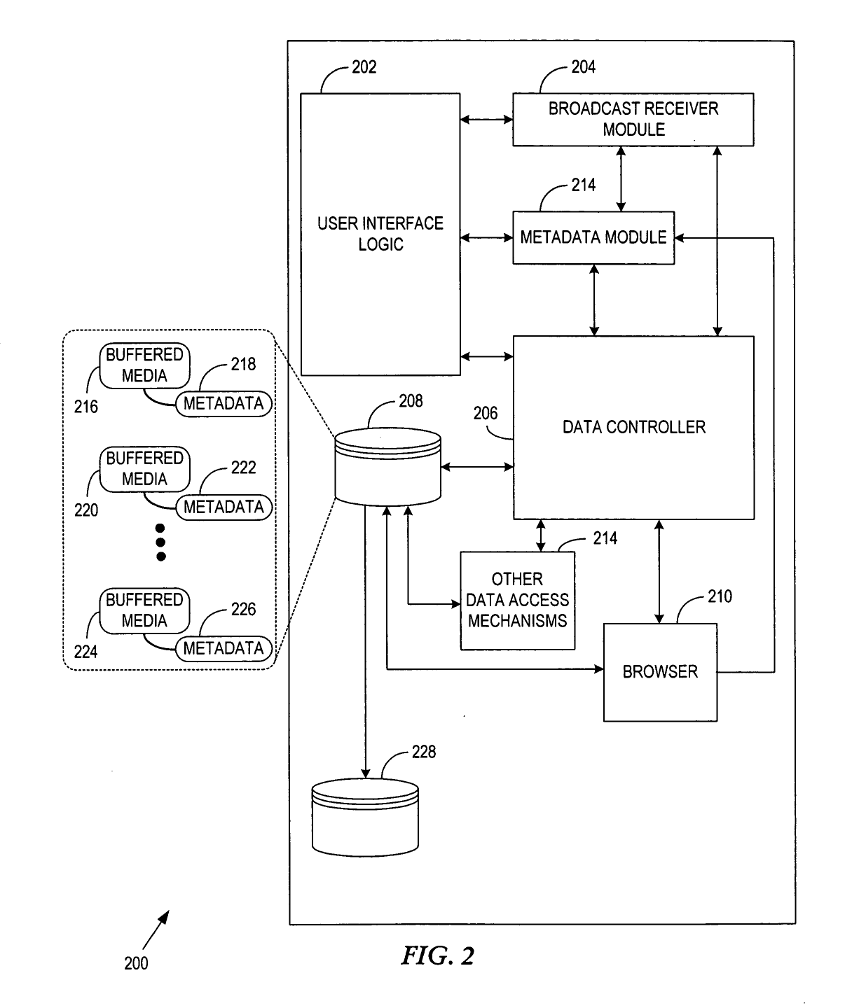

As is discussed in more detail below in relation to FIG. 2, mobile terminal 102 is equipped with one or more media storage devices, e.g., buffered media blocks 216, 220, and 224, that are capable of buffering media streams transmitted by, for example, media broadcast tower 134. The associated metadata is also gathered by mobile terminal 102 either directly, e.g., via DAS or EPG facilities, or indirectly via, e.g., presence server 126, and subsequently stored within metadata storage locations, e.g., metadata blocks 218, 222, and 226, respectively. The buffered media streams may then be recalled at a later time by the user of mobile terminal 102. Recall of the media streams may be facilitated through the use of a search utility existent within browser 210 or other data access mechanism 214, each of which is capable of performing stored media searches based on associated metadata keywords.

A block diagram of exemplary mobile terminal 200 that is in accordance with the present invention is presented in FIG. 2, whereby processing of broadcast media streams, DAS/EPG data, URL content, presence data, etc., allows the creation and buffering of metadata enhanced media files from broadcast media. In one embodiment, mobile terminal 200 establishes a media content channel once the user of mobile terminal 200 tunes to a particular broadcast station transmitted by media broadcast tower 134 of FIG. 1. User Interface (UI) logic block 202 is configured to allow the user of the mobile terminal to select tuning functionality associated with broadcast receiver module 204. For example, the user may access preset broadcast channels from UI logic block 202 that causes broadcast receiver module 204 to tune its receiver in response to the particular broadcast channel selected by the user. The user of mobile terminal 200 is then free to consume the content that is received by broadcast receiver module 204 in response to the tuning command issued by UI logic block 202, while the consumed content is also being buffered within buffer 208 through the use of data controller 206.

In another embodiment, broadcast receiver module 204 may be configured by the user, via UI logic block 202, to continuously receive a preselected channel while the user conducts other operations. In particular, whether the user is conducting, for example, GPRS communication operations with mobile terminal 200 or whether mobile terminal 200 is otherwise in an idle state, broadcast receiver module 204 may nevertheless receive streamed media communications in accordance with the user selected preferences. As such, the received media may be continuously stored within buffered media blocks 216, 220, and 224, while metadata associated with each of the media blocks is gathered and stored within metadata storage blocks 218, 222, and 226, respectively.

Buffered media blocks 216, 220, and 224 may represent the storage locations corresponding to multiple media broadcasts that are simultaneously buffered by mobile terminal 200. In such an instance, for example, broadcast receiver module 204 may incorporate multiple receivers, rN, such that N media streams may be received simultaneously. Each of the N media streams may then be received by data controller 206 and directed to the appropriate storage location, e.g., buffered media blocks 216, 220, and 224, respectively, within buffer 208.

Each of buffered media blocks 216, 220, and 224 may contain a fixed media capacity such that once the data capacity has been reached, alternate functionality may be chosen by the user. In a first embodiment, the user of mobile terminal 200 may elect to archive the buffered media and related metadata into storage location 228 for future reference. In such an instance, once buffered media blocks 216, 220, and 224 have reached capacity, an archive event may take place to transfer the buffered contents into permanent storage 228, whereby buffer 208 is then free to accept new media content and related metadata from data controller 206.

In an alternate embodiment, buffered media blocks 216, 220, and 224 represent circular buffers, whereby a write pointer and a read pointer is maintained for data storage and recovery. For each data block stored within buffered media blocks 216, 220, and 224, for example, the write pointer is incremented, whereas for each data block retrieved from media blocks 216, 220, and 224, the read pointer is incremented. During long periods of data storage, however, the write pointer may be incremented many times before the read pointer is incremented. In such an instance, the write pointer may traverse the entire depth of the circular buffer to subsequently “overrun” the read pointer. Consequently, any data overwritten relative to the write pointer that was not first retrieved relative to the read pointer will be lost.

The amount of media capable of being stored by buffer 208 (and thus the temporal length of each broadcast recorded) is dependent on many factors. For example, the media type and the media device used to receive the media type, along with the coding mechanisms used for the media and related metadata, have a direct influence on the capacity of buffer 208. The number of concurrent media streams to be recorded and their associated data compression algorithms also impact the capacity of buffer 208. In any event, it can be seen that whereas a middle category mobile terminal may facilitate only a single media storage channel having a capacity of 15 minutes, for example, a high end mobile terminal, such as a Personal Digital Assistant (PDA) on the other hand, may provide 2 hours, or more, of multiple media storage channel capability.

Additionally, various search methods may be employed according to the particular device category that the mobile terminal belongs. The middle category mobile terminal, for example, may only provide a few predefined search methods, such as searching for the last song played, the last weather or traffic report, etc. On the other hand, a high end PDA, for example, may offer a highly sophisticated and customizable search interface, which may offer multiple media storage channels having queuing capability to notify the user of “scoring events”, “traffic updates”, “weather reports” and the like. Thus, many levels of operation are contemplated by the present invention and those described herein merely exemplify various embodiments of the invention and are not intended to be limiting in any way.

As mentioned above, mobile terminal 200 may gather metadata associated with each media stream directly from the broadcast that is received by broadcast receiver module 204. In such an instance, metadata module 214 extracts the embedded metadata information, e.g., RDS or EPG, and subsequently provides the data to data controller 206 for subsequent storage into metadata blocks 218, 222, and 226. Thus, as each media stream is received and subsequently delivered to its respect storage buffer, each metadata stream is parsed by metadata module 214 and augmented as necessary to facilitate the media search functions provided by other data access mechanisms 214.

In an alternate embodiment, an indirect mechanism may be employed by mobile terminal 200 to extract the metadata that is to be associated with each media stream. In particular, once a tuning command has been issued by Ul logic block 202 to broadcast receiver module 204, data controller 206 may correlate the tuning command to a URL, or presence server, that is associated with the tuned broadcast station. Once correlated, browser 210 may contact the URL, or presence server, for any metadata that may be associated with the media stream being broadcast by the broadcast station. Once contacted by browser 210, WWW server 130 of FIG. 1, for example, may download all of the relevant media and related metadata to browser 210 for subsequent storage within buffered media blocks 216, 220, and 224 and related metadata blocks 218, 222, and 226, respectively.

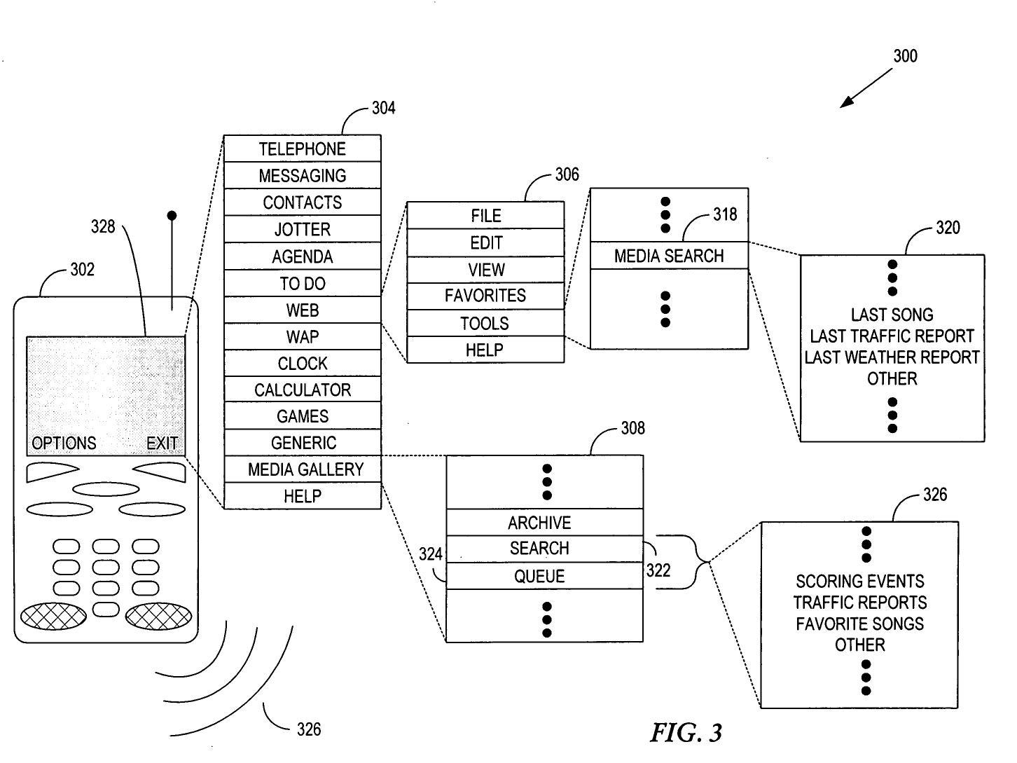

Browsing session 300 of FIG. 3 illustrates exemplary menu options 304 that may be executed by a typical user when, among other functions, the user is performing tasks associated with buffered media streams in accordance with the present invention. In a first embodiment, the user of mobile terminal 302 may perform tasks relating to the MEDIA GALLERY entry of menu options 304, whereby operations on buffered media streams may be initiated on media contained within buffered media blocks 216, 220, and 224 and their associated metadata blocks 218, 222, and 226, respectively.

Among other functions, the user may select the ARCHIVE function of sub-menu 308 to initiate, for example, a buffered media stream transfer from buffer 208 to permanent storage 228 of FIG. 2 as discussed above. Search options 322 and 324 provide functions that allow the user of mobile terminal to establish either a manual or an automatic search, respectively, relating to the buffered media streams contained within buffer 208. Whether a manual or an automatic search option has been selected, the media stream(s) selected for receipt by broadcast receiver module 204 are transferred to buffered media blocks 216, 220, and 224 via data controller 206 as discussed above.

During an automatic search as initiated through selection of search option QUEUE 324, the user may be prompted through any one or more of audible, visible, or tactile means by mobile terminal 302 as to the existence of metadata that meets the automatic search criteria as exemplified by search criteria 326. For example, the user of mobile terminal 302 may have issued a queue search command prior to departing for work, whereby any traffic broadcasts occurring within any of the tuned/received/buffered media streams may be detected by metadata module 214. Once detected, the relevant media streams may then be provided to the user for his or her consumption via a secondary media channel, while the other media streams are being buffered in the background via a primary media channel.

In such an instance, a primary media channel is established, whereby the media stream having buffer 208 as the destination is established to facilitate media stream and related metadata buffering in accordance with the present invention. Once metadata module 214 determines that the metadata associated with the media stream contains a traffic report in accordance with the user's search criteria, then a secondary media channel is established, in which audio portions 326 of the traffic broadcast are delivered to the user. Additionally, any visual portions of the traffic broadcast may also be viewed on display 328 of terminal 302. Still further, tactile queues may be generated in order to alert the user as to the occurrence of the queued search event.

In an alternate embodiment, the user may have established reception of media streams associated with broadcasts of the user's favorite music stations. In addition, a list of the user's favorite songs may have been provided to metadata module 214 via the FAVORITE SONGS search criteria of menu 326. Only those songs having associated metadata, e.g., song titles as determined by metadata module 214, that match the song titles entered as search criteria by the user will be delivered to the secondary media channel to provide audible portions 326 for the user's consumption. All other music broadcasts will be simultaneously buffered in background mode via the primary media channel for future use.

In an alternate embodiment, the user may have established reception of media streams associated with broadcasts of the user's favorite professional football games. In addition, a generic trigger as provided by the SCORING EVENTS search criteria of menu 326, which allows only those broadcasts having a scoring event, such as a touchdown or field goal as detected by metadata module 214, to be delivered to the secondary media channel to provide audible portions 326 for the user's consumption. Video portions of the broadcasted scoring event may also be displayed via display 328 of mobile terminal 302. All other media streams relating to professional football game broadcasts are buffered in the background via the primary media channel for future use.

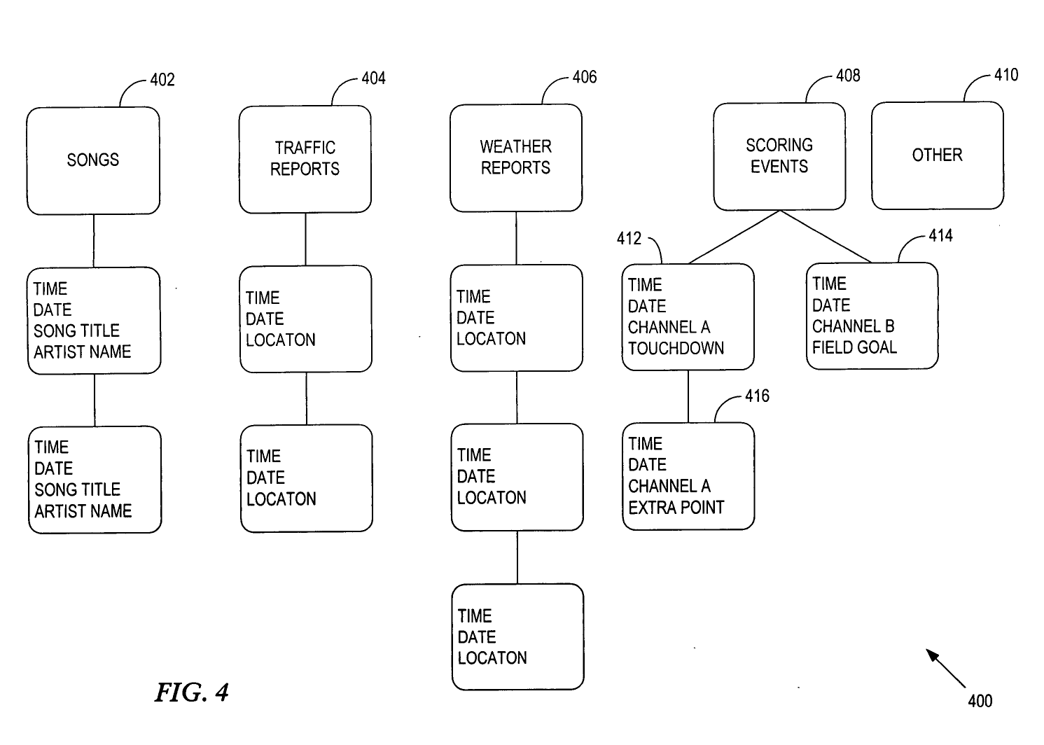

In an alternate embodiment, the user of mobile terminal 302 may have selected SEARCH option 322 of sub-menu 308 as a means to initiate a manual search of media streams already stored within buffer 208, or alternately, within the archived media streams of permanent storage 228. In particular, a free form search may be initiated by the user of mobile terminal 302, whereby a custom search filter may be established for any combination of metadata types, such as time, author, genre, etc. As such, any one or more of search options 326 may be entered by the user to initiate a manual search of buffered or archived media content in accordance with the present invention as discussed below in relation to FIG. 4.

Turning to FIG. 4, an exemplary array 400 is illustrated, which may depict the contents of either buffer 208, or permanent storage 228, as a linked list of metadata records at any given instant in time. Each linked list is categorized into records 402-410 having exemplary titles: songs, traffic reports, weather reports, scoring events, and other, respectively. Under each category, a linked list of metadata records corresponding to the category title exists, whereby every entry in the linked list is time tagged such that the last entry in the list is, for example, the oldest data record in the list. Any metadata record that does not correspond to a specific category may be linked within the other category 410.

Each metadata record of array 400 has a corresponding media storage file associated with it. For example, SCORING EVENTS linked list 408 contains two sub-lists of metadata records, e.g., 412 and 414, that are delineated according to channel numbers A and B. Channel A, for example, may correspond to a first sports broadcast that is received by broadcast receiver module 204 of FIG. 2, whereas Channel B relates to the second sports broadcast channel received. Thus, media content received on Channel A relating to linked metadata list 412 and 416 is stored within, for example, buffered media blocks 216 and 220, respectively, whereas metadata lists 412 and 416 are stored within metadata blocks 218 and 222, respectively. Similarly, media content received on Channel B relating to linked metadata list 414 is stored within, for example, buffered media block 224, whereas metadata list 414 itself is stored within metadata block 226.

In an alternate embodiment, buffered media blocks 216, 220 and the corresponding metadata blocks 218,222 that are associated with Channel A may be merged into a single data record within buffer 208. Similarly, buffered media block 224 and the corresponding metadata block 226 that is associated with Channel B may be merged into a single data record within buffer 208. In either case, buffer 208 is arranged to allow quick data record access by the search engine of other data access mechanisms 214.

As discussed above, metadata collected directly via RDS or EPG utilities may be augmented through indirect collection of metadata via browser 210 of FIG. 2. In such an instance, the search engine of browser 210 may allow the user of mobile terminal 302 to perform tasks relating to the TOOLS entry of WEB options 306, whereby operations on buffered media streams may be initiated on media contained within buffered media blocks 216, 220, and 224 and their associated metadata blocks 218, 222, and 226, respectively. The user of mobile terminal 302 may navigate through the TOOLS sub-menu of WEB menu 306 to conduct media search functions 318 relating to buffered media streams that are associated with indirectly gathered metadata via, for example, WWW server 130 or presence server 126 of FIG. 1 as discussed above. Such an embodiment is contemplated as providing additional features in accordance with the present invention that perhaps the RDS or EPG content of the received media streams would not otherwise provide.

For example, once sub-menu 320 is instantiated, the user of mobile terminal 320 may view the metadata associated with the LAST SONG entry of sub-menu 320, which may correspond to the last song that was buffered from broadcast station 134 of FIG. 1. In so doing, the user may notice that the artist performing the last song recorded is one of the user's favorite artists and may accordingly wish to create a collection of recorded media that pertains to that particular artist. However, the media currently contained within buffer 208 does include media streams from that particular artist.

In an alternate embodiment according to the present invention, therefore, browser 210 may be used to augment the media contained within buffer 208 by accessing media from WWW server 130 or presence server 126 that pertains to that particular artist. In particular, browser 210 may be used to access Internet radio channels that have been previously recorded. The artist's name of the LAST SONG entry of sub-menu 320 is then used by browser 210 during a keyword search of the previously recorded Internet radio channels. If any songs performed by the artist are found to exist within the previously recorded Internet radio channels, then the media and metadata associated with those songs is automatically downloaded by browser 210 and provided to metadata module 214 and data controller 206 for subsequent storage into buffer 208. Thus, it can be seen, that the buffering capability of buffer 208 may be augmented by archived media contained within external devices, such as WWW server 130 or presence server 126, in accordance with the present invention.

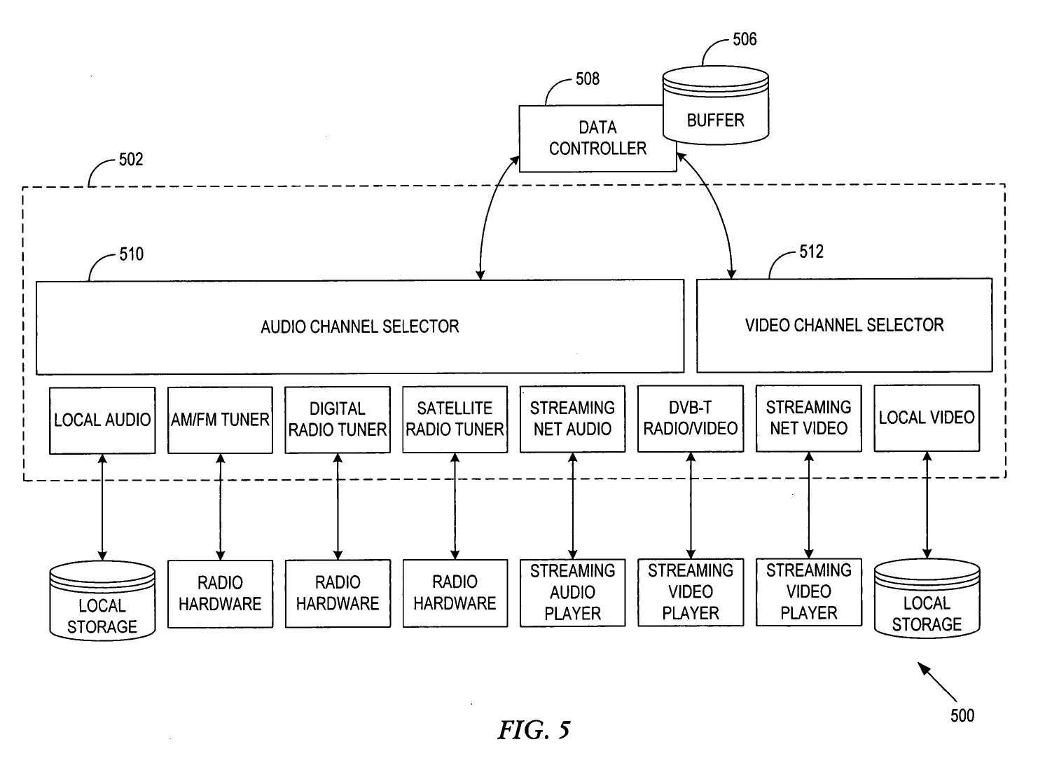

It should be noted that broadcast receiver module 204 of FIG. 2 may be adapted for use with any number of media collection capabilities as exemplified in media access block diagram 500 of FIG. 5. Broadcast receiver module 502 includes audio channel selector 510 that is capable of collecting virtually any audio format including: analog AM/FM, Moving Pictures Expert Group (MPEG) audio, MPEG Layer III (MP3), etc. Video channel selector 512 is capable of collecting virtually any video media format including: WindowsMedia, QuickTime, MPEG version 4 (MPEG-4), and Digital Versatile Disk (DVD), to name only a few. Once collected, the audio/video media is transferred to data controller 508 for buffered storage within buffer 506 as discussed above.

Media access diagram 500 depicts several audio/video access methods available in accordance with the present invention. Audio channel selector 510 may select any audio format from a set of audio formats including: local audio generated in proximity to the mobile terminal; AM/FM tuner; digital radio tuner; satellite radio tuner; streaming net audio; or Digital Video Broadcasting-Terrestrial (DVB-T) radio feeds. Likewise, video channel selector 512 may select any video format from a set of video formats including: DVB-T; streaming net video; or local video feeds generated in proximity to the mobile terminal.

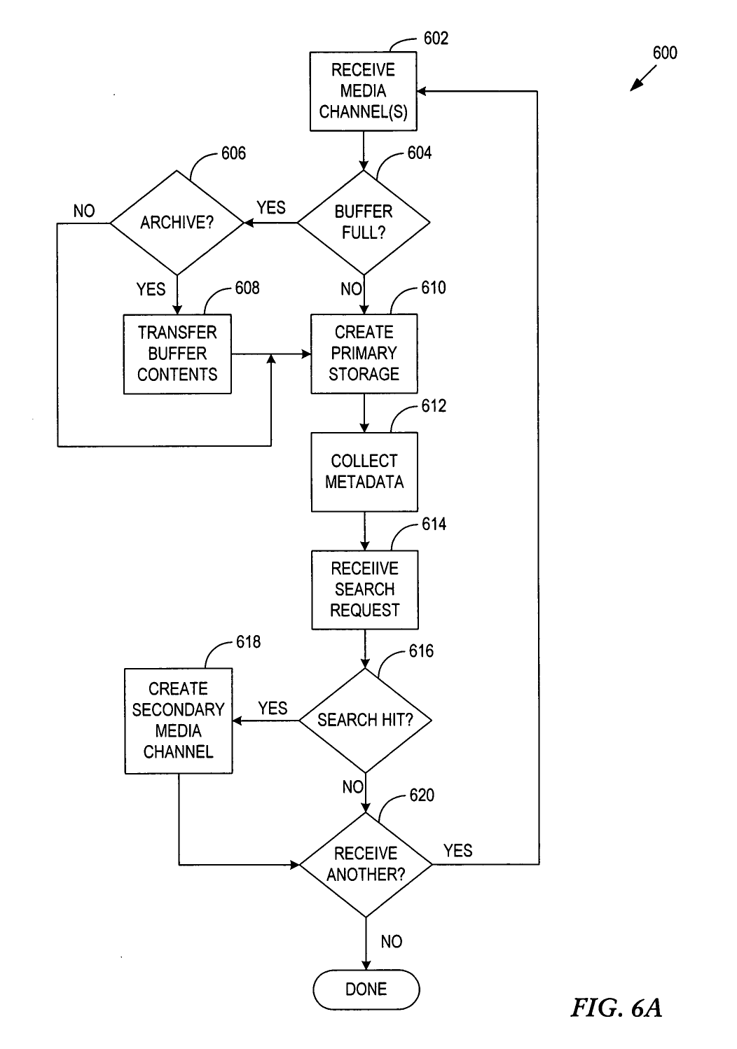

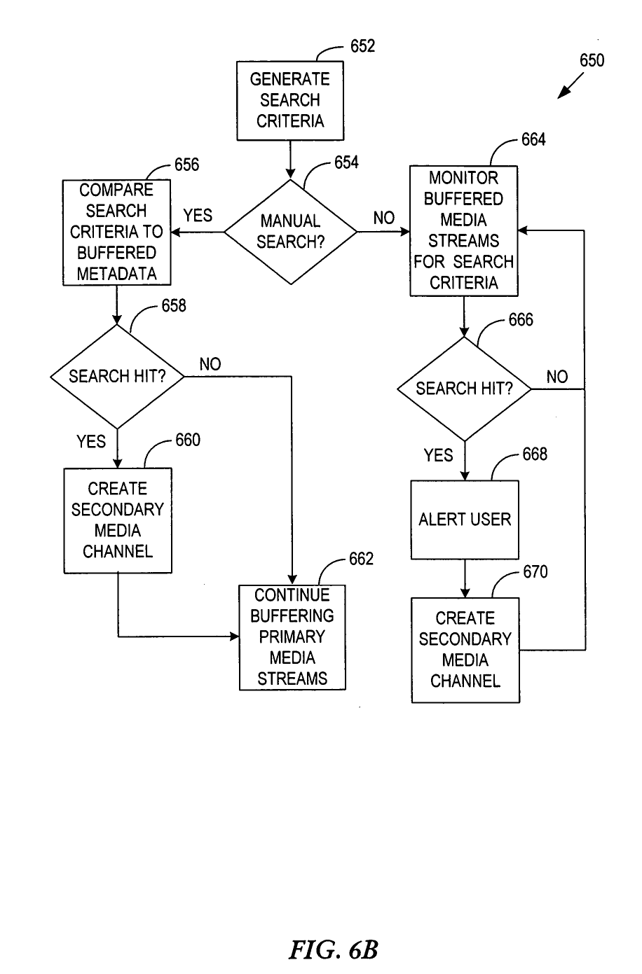

Generally, exemplary methods of storing media streams and related metadata to create searchable media files from streamed media may be described using flow diagrams 600 and 650 of FIGS. 6A and 6B, respectively. It should be noted, that while numerous and detailed steps are being executed in parallel to the steps illustrated in FIGS. 6A and 6B, they are nevertheless left out in the interest of brevity. In step 602, the user of a mobile terminal receives one or more media streams as exemplified in FIG. 5, via broadcast receiver module 502. Once received, an assessment of the storage capacity of buffer 208 is ascertained in step 604. If buffer 208 is at capacity as verified in step 604, the user may be given the opportunity to archive buffer 208 to storage location 228 as in step 608. Otherwise, buffer 208 operates in a circular fashion, whereby contents of buffer 208 are overwritten by newly arriving media stream content and metadata.

Buffered media blocks 216, 220, and 224 are created in step 610 to accept the buffered media streams. The associated metadata blocks 218, 222, and 226, respectively, are created to collect the associated metadata as in step 612. A search request is received in step 614, whereby keywords relating to media stream and metadata storage are received and compared to buffer 208 and/or permanent storage 228 contents. If the specified search criteria is met as determined in step 616, then a second media channel is created as in step 618, whereby the stored media stream associated with the search request is delivered to the user. Audible portions 326 of the recalled media stream as well as video portions 328 of the recalled media stream are delivered to the user via the second media channel. Any other media stream reception actions are considered in step 620 and the process is repeated as necessary.

In alternate flow diagram 650 of FIG. 6B, exemplary manual and automatic search functions are illustrated in accordance with the present invention. In step 652, search criteria, e.g., 326, is generated by the user relating to metadata associated with the buffered media streams. If a manual search is requested as determined in step 654, then the search criteria is used by the search engine of metadata module 214 to conduct searches of metadata stored within buffer 208 or storage 228. If a search hit is registered as determined in step 658, then a secondary media channel is created in step 660, whereby the user is allowed to consume the buffered media associated with the search hit while media streams continue to be buffered as in step 662. Such would be the case, for example, if the user just missed the latest broadcast of the traffic report on the AM/FM channel he is receiving via mobile terminal 200. In such an instance, the user submits a “get last traffic report” search criteria to metadata module 214 via UI logic block 202. The time tagged report is then retrieved from buffer 208 and replayed to the user in its entirety.

Alternately, the user may wish to initiate an automatic search function, whereby all media streams and their associated metadata being received in step 664 are monitored for keyword occurrences. Such would be the case if the user is currently busy with other tasks, but would nevertheless like updates relating to the received media streams so that he may be kept up to date. For example, media streams relating to multiple sporting events occurring simultaneously may be received by the user and buffered by his mobile terminal. The particular keyword occurrence that the user is interested in may be related to “scoring events” that are reported within the broadcasts received by the user. For each scoring event detected in step 666 in each received sports broadcast, an alert is provided to the user in step 668 as to their existence. In addition, a secondary media channel is created for each scoring event as in step 670 and queued for the user's consumption, whereby audible and visible media is presented for the user's enjoyment for each queued scoring event. In this way, the user is kept apprised of the scoring situation for each received sporting event, while being able to focus his attention on other tasks.

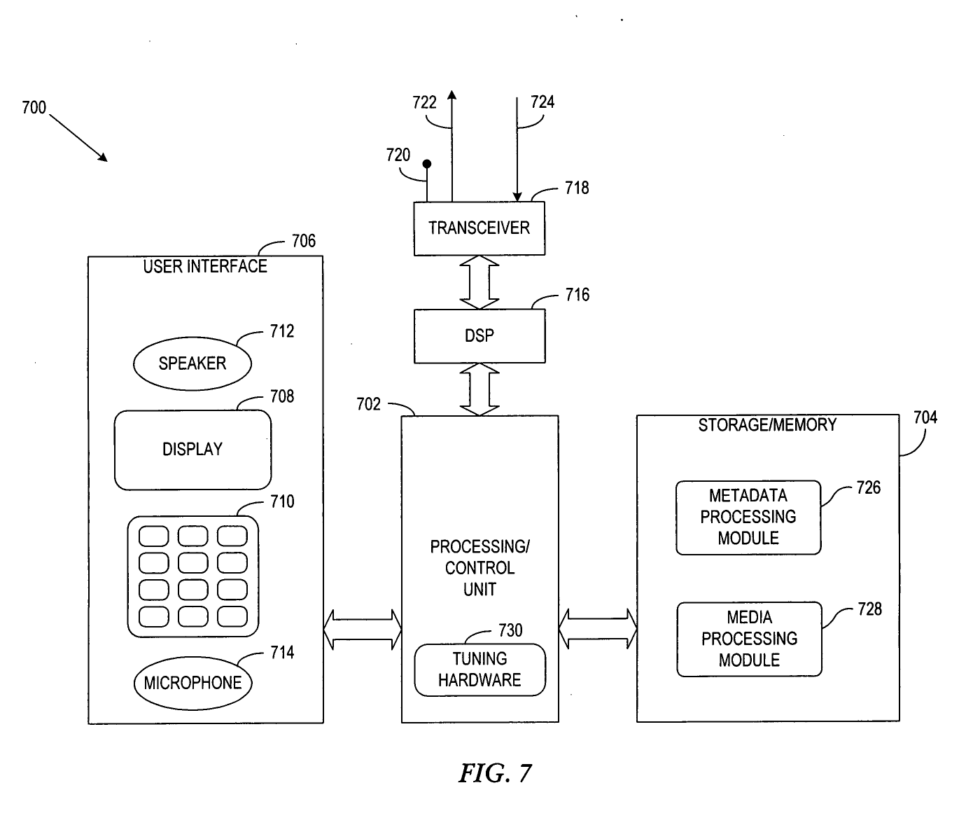

The invention is a modular invention, whereby processing functions within a mobile or landline terminal may be utilized to implement the present invention. The mobile devices may be any type of wireless device, such as wireless/cellular telephones, PDAs, or other wireless handsets, as well as portable computing devices capable of wireless communication. These landline and mobile devices utilize computing circuitry and software to control and manage the conventional device activity as well as the functionality provided by the present invention. Hardware, firmware, software or a combination thereof may be used to perform the various media storage and search functions described herein. An example of a representative mobile terminal computing system capable of carrying out operations in accordance with the invention is illustrated in FIG. 7. Those skilled in the art will appreciate that the exemplary mobile computing environment 700 is merely representative of general functions that may be associated with such mobile devices, and also that landline computing systems similarly include computing circuitry to perform such operations.

The exemplary mobile computing arrangement 700 suitable for creating searchable media files in accordance with the present invention may be associated with a number of different types of wireless devices. The representative mobile computing arrangement 700 includes a processing/control unit 702, such as a microprocessor, reduced instruction set computer (RISC), or other central processing module. The processing unit 702 need not be a single device, and may include one or more processors. For example, the processing unit may include a master processor and associated slave processors coupled to communicate with the master processor.

The processing unit 702 controls the basic functions of the mobile terminal, and also those functions associated with the present invention as dictated by metadata processing module 726 and media processing module 728 in combination with tuning hardware module 730. Thus, the processing unit 702, in conjunction with metadata processing module 726 and media processing module 728, is capable of accessing metadata that is associated with a particular media stream and combining the metadata and media stream into a searchable data record in accordance with the present invention. The program storage/memory 704 may also include an operating system and program modules for carrying out functions and applications on the mobile terminal. For example, the program storage may include one or more of read-only memory (ROM), flash ROM, programmable and/or erasable ROM, random access memory (RAM), subscriber interface module (SIM), wireless interface module (WIM), smart card, or other removable memory device, etc.

In one embodiment of the invention, the program modules associated with the storage/memory 704 are stored in non-volatile electrically-erasable, programmable ROM (EEPROM), flash ROM, etc. so that the information is not lost upon power down of the mobile terminal. The relevant software for carrying out conventional mobile terminal operations and operations in accordance with the present invention may also be transmitted to the mobile computing arrangement 700 via data signals, such as being downloaded electronically via one or more networks, such as the Internet and an intermediate wireless network(s).

The processor 702 is also coupled to user-interface 706 elements associated with the mobile terminal. The user-interface 706 of the mobile terminal may include, for example, a display 708 such as a liquid crystal display, a keypad 710, speaker 712, and microphone 714. These and other user-interface components are coupled to the processor 702 as is known in the art. Other user-interface mechanisms may be employed, such as voice commands, switches, touch pad/screen, graphical user interface using a pointing device, trackball, joystick, or any other user interface mechanism.

The mobile computing arrangement 700 also includes conventional circuitry for performing wireless transmissions. A digital signal processor (DSP) 716 may be employed to perform a variety of functions, including analog-to-digital (A/D) conversion, digital-to-analog (D/A) conversion, speech coding/decoding, encryption/decryption, error detection and correction, bit stream translation, filtering, etc. The transceiver 718, generally coupled to an antenna 720, transmits the outgoing radio signals 722 and receives the incoming radio signals 724 associated with the wireless device.

The mobile computing arrangement 700 of FIG. 7 is provided as a representative example of a computing environment in which the principles of the present invention may be applied. From the description provided herein, those skilled in the art will appreciate that the present invention is equally applicable in a variety of other currently known and future mobile and landline computing environments. For example, desktop computing devices similarly include a processor, memory, a user interface, and data communication circuitry. Thus, the present invention is applicable in any known computing structure where data may be communicated via a network.

Using the description provided herein, the invention may be implemented as a machine, process, or article of manufacture by using standard programming and/or engineering techniques to produce programming software, firmware, hardware or any combination thereof. Any resulting program(s), having computer-readable program code, may be embodied on one or more computer-usable media, such as disks, optical disks, removable memory devices, semiconductor memories such as RAM, ROM, PROMS, etc. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create searchable media objects in accordance with the present invention.

The foregoing description of the various embodiments of the invention has been presented for the purposes of illustration and description. It is not intended to be exhaustive or to limit the invention to the precise form disclosed. Many modifications and variations are possible in light of the above teaching. Thus, it is intended that the scope of the invention be limited not with this detailed description, but rather determined from the claims appended hereto.

1. A system for creating searchable media objects associated with a media stream received from a broadcasting entity of a network, the system comprising:
a network terminal coupled to the network, the network terminal including, a broadcast receiver module coupled to the broadcasting entity and adapted to receive media streams from the broadcasting entity;
a metadata module coupled to receive metadata relating to the received media streams and adapted to associate the metadata with the received media streams; and
a data controller coupled to the broadcast receiver module and the metadata module and adapted to combine the media streams received from the broadcasting entity with the associated metadata to form the searchable media objects.

2. The system according to claim 1, wherein the mobile terminal further comprises a browser adapted to download additional metadata from a Uniform Resource Locator (URL) associated with the broadcasting entity.

3. The system according to claim 1, wherein the metadata module comprises a Radio Data Service (RDS) module adapted to extract the metadata from a broadcast channel of the broadcasting entity.

4. The system according to claim 1, wherein the metadata module comprises an Electronic Program Guide (EPG) module adapted to extract the metadata from a broadcast channel of the broadcasting entity.

5. The system according to claim 1, wherein the mobile terminal further comprises a buffer adapted to temporarily store the searchable media objects.

6. The system according to claim 5, wherein the mobile terminal further comprises a storage device coupled to the buffer and adapted to permanently store the searchable media objects transferred from the buffer.

7. A mobile terminal capable of being wirelessly coupled to a network which includes a broadcast element capable of providing broadcast content within the network, the mobile terminal comprising:
a broadcast receiver module capable of being coupled to the broadcast element and adapted to receive the broadcast content;
a metadata module coupled to receive metadata relating to the broadcast content and adapted to associate the metadata with the broadcast content; and
a data controller coupled to the broadcast receiver module and the metadata module and adapted to combine the broadcast content with the associated metadata to form media objects, wherein the media objects are recalled in response to metadata based keyword searches performed on the media objects.

8. The mobile terminal according to claim 7, wherein the mobile terminal further comprises a browser adapted to download additional metadata from a Uniform Resource Locator (URL) associated with the broadcast element.

9. The mobile terminal according to claim 7, wherein the metadata module comprises a Radio Data Service (RDS) module adapted to extract the metadata from a broadcast channel of the broadcast element.

10. The mobile terminal according to claim 7, wherein the metadata module comprises an Electronic Program Guide (EPG) module adapted to extract the metadata from a broadcast channel of the broadcast element.

11. The mobile terminal according to claim 7, wherein the mobile terminal further comprises a buffer adapted to temporarily store the searchable media objects.

12. The mobile terminal according to claim 11, wherein the mobile terminal further comprises a storage device coupled to the buffer and adapted to permanently store the media objects transferred from the buffer.

13. A computer-readable medium having instructions stored thereon which are executable by a mobile terminal for facilitating searchable media file creation by performing steps comprising:
receiving media streams;
receiving metadata associated with the received media streams;
combining the media streams and metadata into searchable media files;
buffering the searchable media files; and
recalling the searchable media files for playback in response to keyword searches relating to the metadata.

14. A method for creating and utilizing searchable media files, comprising:
receiving media streams;
collecting metadata associated with the media streams;
combining the media streams with the metadata in a buffer;
recalling the media streams from the buffer based on metadata keyword searches of the buffer; and
replaying the recalled media stream while continuing to receive other media streams.

15. The method according to claim 14, wherein collecting the metadata comprises downloading the metadata from a Uniform Resource Locator (URL) associated with a broadcast entity.

16. The method according to claim 14, wherein collecting the metadata comprises deriving the metadata from a Radio Data System (RDS) broadcast.

17. The method according to claim 14, wherein collecting the metadata comprises deriving the metadata from an Electronic Program Guide (EPG).

18. A method of performing metadata based search of media files, comprising:
generating search criteria from metadata keywords;
selecting a search method to utilize;
comparing the search criteria to metadata indexed media files in response to the search method selected; and
recalling the metadata indexed media files in response to a search criteria match.

19. The method according to claim 18, wherein selecting the search method comprises selecting an automatic search method, wherein the search criteria is compared to media streams as they are received.

20. The method according to claim 18, wherein selecting the search method comprises selecting a manual search method, wherein the search criteria is compared to
